(19) United States
(12) Patent Application Publication
(10) Pub. No.: US 2014/0051480 A1
(43) Pub. Date: Feb. 20, 2014

(54) Mobile Phone Microwave Radiation Protection

(71) Applicant: John Fred Cruz, Salt Lake City, UT (US)

(72) Inventor: John Fred Cruz, Salt Lake City, UT (US)

(21) Appl. No.: 13/969,227

(22) Filed: Aug. 16, 2013

Related U.S. Application Data
(60) Provisional application No. 61/684,257, filed on Aug. 17, 2012.

(51) Int. Cl. H04B 1/38

(52) U.S. Cl. CPC H04B 1/3838
USPC 455/566; 455/575.5

(57) ABSTRACT

Microwave radio signals are used to transmit data/voice between mobile phone and cellular towers. The invention is used to reflect and/or block significantly levels of microwave radio signals directed out of the front of the mobile phone. The invention applies to the face of the mobile phone providing a protective shield when the front of the mobile phone is held next to the head or body when microwave radiation absorption can take place into the body. Since the shielding is applied only the front of the phone the microwave signals directed out the sides and back of the phone connect and communicated unobstructed to the cell phone towers.

BACKGROUND OF INVENTION

Microwave radio signal technology is used in communicating and transferring voice and data to cell phone towers. Consumers hold mobile phone devices next to their body to talk through the device when electromagnetic energy is being reported as a potentially harmful. Mobile phone consumers have a growing concern about these radio signals affecting their and their children's health. My invention is significant because it is designed to be effective when applied on the mobile phone and held next to the body between the cell phone user and the cell phone providing protection (“shielding”) from microwave radiation (“EMF” and also referred to as radio signals) reported adverse health affect associated to microwave radiation.

The effect of mobile phone radiation on human health is the subject of global interest and study as a result of the enormous increase in mobile phone usage throughout the world and increase in various adverse health effects. Mobile phones have now been in use for a longer period of time. It was originally believe the low voltage of microwave radiation was harmless. Now as health institutions study more data and compared growing trends of possibly related health issues, many worldwide warnings have been issued about holding the mobile device next to the body when the device is switched on.

In May 2011, the World Health Organization has classified mobile phone radiation on the IARC scale into Group 2B—possibly carcinogenic. That means that there “could be some risk” of carcinogenicity, so additional research into the long-term, heavy use of mobile phones needs to be conducted. Health institutes globally recommend mobile phone users to take measures to minimize exposure to their citizens as a precautionary approach.

In August 2012, United States Government Accountability Office (GAO) asked the Federal Communications Commission to consider updating the standard, which limits the amount of radiation a phone emits. The report recommended following an international standard, which would allow U.S. cell phones to emit up to 20% more radiation than currently allowed.

The GAO also asked the FCC to consider updating its cell phone testing procedures to account for phones being used while next to the body—such as in a pocket or held in your hand.

While people use cell phones for talking, these devices have also evolved into small portable computers, music players and various multipurpose communication tools such as email, video chatting and more. It is now common to see people using cell phones placed in their pockets or tucking it inside their sports clothing with attached earphones or wireless headsets. However the mobile phone which is the source of the transmitting electromagnetic frequencies is placed in the pocket or inside the sport clothing of the cell phone user, again, next to the body, the basis of the health warnings.

Even when the mobile device is not being used, it is most often placed in pockets or stuffed inside jeans or sporting clothing when not in use. Even when the mobile phone is not being use, it continues to send out microburst of microwave energy to remain connected to nearby cell phone towers. It is reported that the absorption of microwave energy is accumulative. This energy would therefore be adsorbed and accumulated by the body of the cell phone user also making my invention valuable when the mobile phone is not being use.

Mixed reports have been issued by the mobile phone industry about the validity of any adverse health affect studies, claiming these independent studies are in-conclusive in its findings. Regardless a growing consumer market does not wish to take the risks and wait for the mobile phone industry to validate the health studies. Also health minded mobile phone users do not want to hold magnetic cases to their heads. My case uses a polyurethane sleeve or cutout, depending upon model, that fits into a viewing window cutout on the lid that fits over the mobile phone face, as the attachment method that adheres the microwave shielding lid to the face of the mobile phone without adhesives, snaps or magnetic. And consumers validate my invention as a practical application to meet the precautions issued by non-funded mobile phone industry studies.

### DESCRIPTION OF INVENTION

Radio signals emit out in all directions from the mobile device in attempts to connect to the cell phone tower. The radio signal energy that is directed at the body is the focus of my invention. My invention is designed to be placed on the face of the mobile device between the cell phone user and the cell phone providing shielding by reflection or absorption or a combination of both body blocking out microwave signals emitting out the face of the phone toward the mobile phone user. As a result the level of electromagnetic radio signals are reduced or eliminated so consequently is the level of potential absorption as well. And all remaining radio signals continue transmitting out the back and side uninterrupted to provide connection to its nearest accessible cell tower and while protecting the soft tissue in the body, less resistant to such radio signals.

My invention might be compared in functionality to that of an umbrella protecting (“shielding”) from the sun rays, or a leaded chest vest protecting (“shielding”) from x-ray energy when getting x-rays at the dentist office.

My invention has two components. They consist of an 1) outer flexible polymeric (polymer, silicone and/or soft vinyl material) sleeve, cover or layer that construct a protective outer shell, also referred herein as pad, envelop or mobile phone lid manufactured into the mobile phone case that contains 2) an inner component consisting of the shielding material lining designed to block analogue and pulsed digital microwave signals emitted from the mobile phone. The shielding material provides +20 dB or greater attenuation (blocking) necessary to provide adequate biological shielding from frequencies that include 500 MHz to 9 GHz. The shielding lining is manufactured using a fine transparent metal mesh fabric, a clear film, a paint, ribbon and/or foil.

Component 2: The inner component is a fine metal mesh fabric, treated film, paint and/or foil manufactured to provide +20 dB attenuation of microwave signals. The shielding material is inserted inside the sleeve (Component 1) and secured with an adhesive or sewn into the structure so that it is not easily removed or accessed by the consumer. The microwave radio shielding material maybe be reinforced by a polymer or plastic backing for easy of insertion into the sleeve and/or case cover. Opaque versions or flip lids with a viewing window provide the added feature of a privacy of the cell phone touch screen. The sleeve provides a protective cover for the phone and may include a slight skid resistance feature when the cell phone is placed face down on most dust free table tops.

### DESCRIPTION OF IMAGES

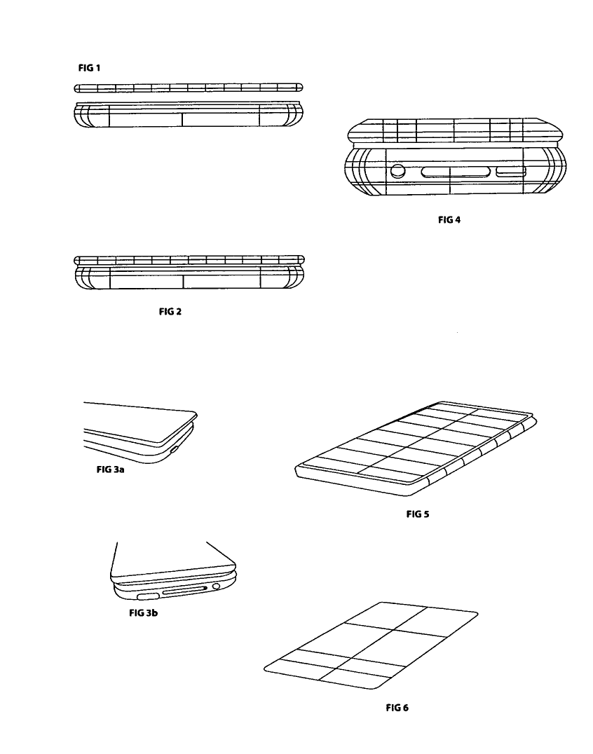

FIG. 1 is a side view of the invention with the microwave shielding lid raised over the face of the mobile phone. This figure demonstrates how the invention is placed on the face of the mobile phone blocking and/or reflecting the microwave signals that are directed to the face when talking or body when carrying in a pocket.

FIG. 2 is a side view of the invention comprising a full mobile phone case with flip lid that lays flat over the face of the mobile phone.

FIG. 3a is a side elevated angle view of a shielded lid resting on the face of a mobile phone.

FIG. 3b is a front elevated angle view of the shielded lid resting on the face of the mobile phone.

FIG. 4 is a bottom view of the mobile phone case conforming around the mobile phone with shielding fabric cover setting on the face of mobile device on the lid that closes to the face of the mobile phone. The case covering exposes the mobile phone portals to easy access while the shielding case is attached.

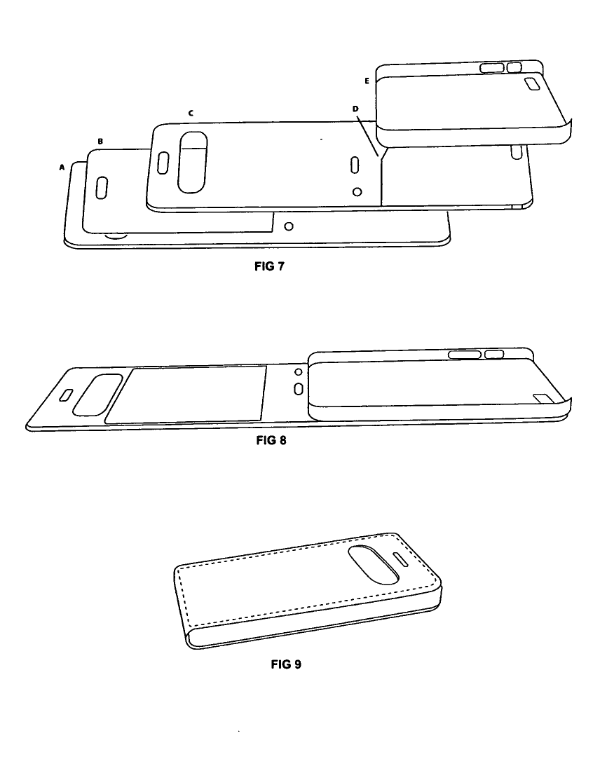

FIG. 5 is an illustration of the polymeric sleeve/lid that contains the microwave radio signal shielding material. Viewing and speakers holes are punched into the lid appropriate to the mobile phone.

FIG. 6 is the shielding fabric and or film cut and/or manufactured to insert into the cover/sleeve shown in the illustrations.

FIG. 7. This is an exploded product view of the mobile phone microwave protection mobile phone case with its components. A.) The outer cover, which can be made from vinyl, leather, metal or other materials that protect the shielding fabric or film inside on the cover and the phone itself. B) This layer contains the microwave radio signal shielding/protection that is placed over the face of the mobile phone. The shielding material provides +20 dB of attenuation of the microwave signals that includes but not limited to 500 Mhz and 3 GHz directed from the face of the mobile phone and the shielding material lid. C) This layer is the inside liner sealing the cover (A) and liner with the shielding material (B) in between. D) This layer is a hidden card holder that adheres or sewn onto liner C. E) Is the molded plastic or rubber phone holder for the mobile phone to attach to the microwave radiation protective mobile phone case.

FIG. 8 illustrates the mobile phone case laying open with the liner and mobile phone case holder exposed.

FIG. 9 illustrates the microwave radiation protective mobile phone case closed with the shielding cover on the face of the mobile phone providing a protection layer between the mobile phone and mobile phone user.

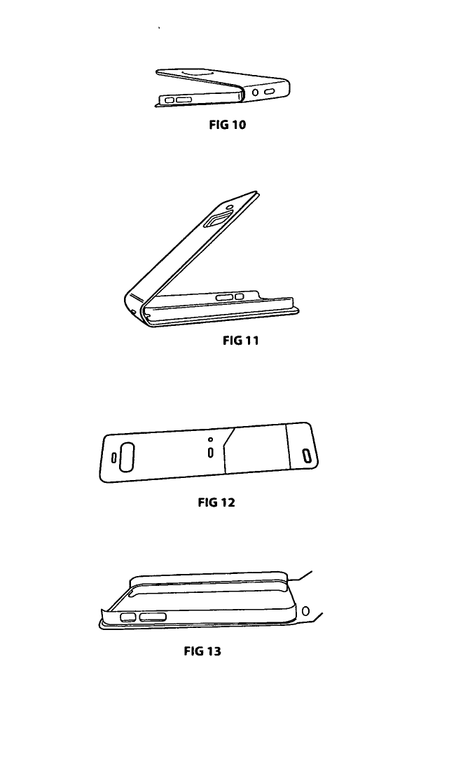

FIG. 10 is an angled left side-rear view illustration of the microwave radiation protective mobile phone case slightly open and holes punched into the case for speaker and power cables.

FIG. 11 is a right side view of the mobile phone case with the shielding flip lid slightly opened over the mobile phone holder.

FIG. 12 is open view of an open mobile phone case without the mobile phone holder exposing the card holder. This illustration displays viewing windows, speaker, ear phones and power charger holes punched into the mobile phone case.

FIG. 13 is an illustration of the cell phone holder that is adhered above the card holder and liner. This illustration demonstrates the card holder hided under the cell phone holder.

1-14. (canceled)

15. A method for reducing mobile phone microwave radio signals directed to the head or body of the mobile phone user by comprising of a inserted and enclosed in a cover keeping the shielding material against the face of the mobile phone and providing a protective shielding barrier between the mobile phone user and the mobile phone microwave signals that are being transmitted.

16. Wherein the shielding material in claim 15 is of a mesh metal fabric, clear film, paint or foil manufactured to block or reflect analogue and/or pulsed digital microwave signals used by cell phone.

17. Wherein the cover referenced in claim 15 is entirely or in part comprised of polyurethane or other soft plastic film that when pressed against the mobile phone display screen adheres to the display screen of the mobile phone.
